(19) United States
(12) Patent Application Publication
(10) Pub. No.: US 2010/0320363 A1
(43) Pub. Date: Dec. 23, 2010

(54) OPTICAL SENSOR FOR MEASURING EMISSION LIGHT FROM AN ANALYTE

(75) Inventor: Johannes J.H.B. Schleipen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/918,089

(22) PCT Filed: Feb. 19, 2009
(86) PCT No.: PCT/IB09/50678

§ 371 Date: Aug. 18, 2010

(30) Foreign Application Priority Data
Feb. 25, 2008 (EP) 08305031.0

(51) Int. Cl. H01J 40/00; G01N 21/64

(52) U.S. Cl. 250/200; 250/459.1

(57) ABSTRACT

The invention provides an optical sensor (100). The optical sensor (100) comprises a planar waveguide (120) capable of emitting radiation (22) in a direction perpendicular to the sensor waveguide surface (122) and capable of accepting and transmitting radiation (16) to detector (140), preferably a planar detector (140). Further, optionally one or more lenses (133), one or more spectral filters (131) and one or more polarisation filters (132) may be arranged between the waveguide (120) and the detector (140). The optical sensor (100) is especially arranged to read out a wire grid substrate (200) with analytes (10).

### FIELD OF THE INVENTION

The invention relates to an optical sensor for measuring emission light from an analyte as well as to a method for measuring emission light from the analyte with an optical sensor.

### BACKGROUND OF THE INVENTION

Optical sensors, such as biosensors, for measuring quantitatively and/or qualitatively the presence of analytes are known in the art.

WO 2006/136991 for instance discloses a qualitative or quantitative luminescence sensor, for example a biosensor or chemical sensor, using sub-wavelength aperture or slit structures, i.e. using apertures or slit structures having a smallest dimension smaller than the wavelength of the excitation radiation in the medium that fills the aperture or slit structure.

The luminescence sensor system of WO 2006/136991 comprises a luminescence sensor, an excitation radiation source and a detector. The luminescence sensor comprises a substrate provided with at least one aperture or slit having a smallest dimension and with at least one luminophore in the at least one aperture for being excited by excitation radiation having a wavelength. The at least one aperture or slit is being filled with a medium. The medium may be a liquid or a gas, but may also be vacuum comprising at least one luminescent particle to be detected. In use the sensor may be immersed in the medium, e.g. in a liquid medium, or the at least one aperture or slit may be filled with the medium in any other suitable way, e.g. by means of a micropipette in case of a liquid medium, or e.g. by spraying a gas over the sensor and into the at least one aperture or slit. The smallest dimension of the at least one aperture or slit is smaller than the wavelength of the excitation radiation in the medium that fills the at least one aperture. The luminescence sensor has a first and a second side being opposite to each other.

WO 2006/136991 further discloses a method for the detection of luminescence radiation generated by at least one luminophore in at least one aperture or slit in a substrate, the at least one aperture or slit having a smallest dimension and being filled with a medium such as a liquid or a gas. The method of WO 2006/136991 comprises exciting the at least one luminophore by means of an excitation radiation at a first side of the substrate, the excitation radiation having a wavelength, in the medium that fills the aperture or slit, the wavelength being larger than the smallest dimension of the at least one aperture or slit, and detecting luminescence radiation coming from the at least one excited luminophore at a second side of the substrate, the second side being opposite to the first side. The wavelength of the excitation radiation in the medium that fills the aperture or slit may be at least a factor 2 larger than the smallest dimension of the at least one aperture or slit.

Other methods that may be applied may for instance use the projection of excitation light on the sample using (i) a (polarizing-) beam splitter, or using (ii) dark field illumination. Both methods may require 3-dimensional volumetric optics.

### SUMMARY OF THE INVENTION

A disadvantage of prior art sensors may be that such sensors are relatively bulky sensors. Other disadvantages of the prior art may be necessity to use relatively complicated optical solutions to measure emission from analytes.

Hence, it is an aspect of the invention to provide an alternative optical sensor, which preferably further obviates one or more of above-described drawbacks. It is another aspect of the invention to provide an alternative method for measuring emission light of the analyte with an optical sensor which also preferably further obviates one or more of above-described drawbacks.

The current invention proposes in an embodiment the use of a waveguide, especially a substantially planar waveguide, where excitation light (wavelength λ) is coupled in from the side. The light is reflected at the top and bottom surface of the waveguide by total internal reflection. Furthermore the top surface of the waveguide may contain a diffraction grating such that the 1^{st} order is coupled out along a direction (preferentially) substantially parallel to the surface normal, i.e. substantially perpendicular to the top surface. In this way, a substantially planar structure for coupling out light in a direction perpendicular to the planar object may be obtained.

Furthermore, in the invention, a combination of grating pitch and grating entrance angle such that the excitation light (λₑₓ) (first order) is coupled out by the diffraction grating, whereas the emission light with wavelength λₑₘ=λₑₓ+Δλ is being transmitted by the diffractive structure, may be applied: substantially no diffraction orders may exist at the red shifted luminescence. Consequently, the luminescent light is not substantially coupled back into the waveguide and can be imaged with maximum intensity and field (using for instance a 2D micro lens array) on a 2D detector, positioned adjacent to the waveguide.

In this way all optical components, including detection optics, and optionally also including illumination optics, may be substantially planar in geometry and can be stacked easily on top of a 2D-sensor, resulting in a compact planar optical imaging device for reading an analyte, for instance on a wire-grid substrate.

Such a wire-grid substrate may allow coupling of light inside the medium containing the analyte, the light penetrating the medium over only a very small distance, this distance being smaller (typically about λₑₓ/10) than the wavelength (λₑₓ) of the excitation light. The polarisation of the excitation light is preferably parallel to the (metallic) wires, defining the wire grid. As a result only analytes may be probed that are bio-chemically bound to the surface, thereby providing a means for for instance detecting the analyte concentration in a bio-assay. Typically the width or pitch of the slits of the wire grid is less than about λₑₓ/(2n), where λₑₓ is the wavelength of the excitation light and n is the refractive index of the medium in between the metallic wires of the wire grid substrate (e.g. air or water).

Therefore, in a first aspect, the invention provides an optical sensor for measuring emission light from an analyte, the optical sensor comprising a, preferably substantially planar, waveguide and an optical detector, the waveguide comprising:

a. a light input waveguide surface arranged to couple light from a light source into the waveguide;

b. a sensor waveguide surface arranged to couple out at least part of the incoupled light source light as excitation light to excite the analyte and arranged to couple into the waveguide at least part of the emission light from the analyte as incoupled emission light;

c. a detector directed waveguide surface arranged substantially parallel with the sensor waveguide surface, and arranged to couple out at least part of the incoupled emission light in the direction of the optical detector as waveguide outcoupled emission light;

wherein the optical detector is arranged to detect at least part of the waveguide outcoupled emission light.

Advantageously, in this way a relatively planar sensor may be provided, for instance for measuring biological samples, such as salvia, blood etc., on for instance wire grid bio substrates.

In an embodiment, the sensor waveguide surface comprises a diffraction grating (also indicated as “grating” or “grating coupler”), wherein the diffraction grating is arranged to couple out excitation light with a predetermined wavelength in a first order diffraction substantially perpendicular to the sensor waveguide surface. In this way, outcoupling of light may be enabled and excitation light with a predetermined wavelength can be provided to the analyte. Further, in an embodiment, the diffraction grating is substantially transmissive for emission light with a predetermined wavelength, more especially for such emission perpendicular to the sensor waveguide surface. Since the grating may be blazed to the predetermined wavelength, and the emission of the analyte will in generally be (Stokes-) shifted relative to excitation light, the grating is on the one hand arranged to allow excitation light in first order, and substantially perpendicular to the sensor waveguide surface, escape from the waveguide, and on the other hand, arranged to allow emission light substantially unhindered enter the waveguide.

In a specific embodiment, the predetermined wavelength (λₑₓ) of the excitation light is selected from the visible range, especially in the range of about 380-780, more especially in the range of about 550-700 nm.

Herein the term “selected from the range” indicates that the light, here the excitation light, at least comprises light with a wavelength of equal to or larger than about 550 nm and equal to or smaller than about 700 nm. This does not exclude embodiments, wherein the light can be presented as a band, having a final width (FWHM; full width at half maximum), which band may also extend above and/or below the range. Especially, the dominant wavelength of the light, here excitation light, is in the indicated range. Herein, the term “wavelength” in general relates to the predetermined wavelength.

As mentioned above, the grating is especially arranged to allow excitation light with the predetermined excitation wavelength couple out in first order, and especially couple out substantially perpendicular to the sensor waveguide surface. In a further embodiment, the diffraction grating has a grating pitch in the range of about 400-600 nm, such as 400-500 nm. The term “grating pitch” is known in the art and especially relates to the regular distance between the periodic structures of the grating, such as between saw teeth structures or square wave structures.

Further, as indicated above, the grating may further be arranged to allow emission light (especially perpendicular to the sensor waveguide surface) with a predetermined emission wavelength substantially unhindered enter the waveguide. In a specific embodiment, the predetermined wavelength (λₑₘ) of the emission light is selected from the visible and infra-red (IR) range, especially in the red and IR, more especially in the range of about 500-1000 nm, even more especially in the range of about 650-900 nm.

In order to improve the detected signal or to improve the derivation of information from the detected signal, downstream of the detector directed waveguide surface and upstream of the detector one or more optical elements may be arranged. Such optical elements may be selected from the group consisting of an optical filter, a polarizer and a micro lens array are arranged. More than one of such optical elements may be applied. In a specific embodiment, the optical elements are arranged to provide downstream from the detector directed waveguide surface and upstream of the detector a first micro lens array, (downstream thereof) an optical filter, (downstream thereof) a polarizer, and (downstream thereof) a second micro lens array, respectively.

The detector may comprise a photodiode, or a CCD or a CMOS detector. Such detectors are known in the art; CCD and CMOS detectors relate to charged coupled devices (CCD) and complementary metal oxide semiconductors (CMOS), respectively. Such detectors may also be indicated as 2D detectors. Further, also a scanning approach may be used, for instance in which only a small imaging view is obtained. In such embodiment, light may be collected on a photodiode for a certain time; in such a way that optimal signal to noise may be obtained. In a specific embodiment, the detector is arranged to detect light with a wavelength (i.e. predetermined emission wavelength) selected from the range of about 650-900 nm.

The waveguide may especially be a substantially planar device. In such planar waveguide, the sensor waveguide surface and the detector directed waveguide surface are substantially parallel, i.e. especially arranged under mutual angle(s) of equal to or less than 5° (i.e. in the range of)0-5°, especially mutual angle(s) equal to or less than 1° (i.e. in the range of)0-1°. Further, when using detectors like photodiodes, CCD or CMOS, also the detectors may be substantially planar, thereby providing the planar device. Hence, in a specific embodiment, the optical sensor is a substantially planar device, i.e. the combination of waveguide and detector is arranged to obtain a substantially planer sensor.

The light source may be part of the optical sensor, i.e. integrated in the optical sensor, or may be separate of the optical sensor. Suitable light sources are for instance light emitting diodes, laser diodes, or any other kind of laser system, emitting light with the right excitation wavelength (i.e. predetermined excitation wavelength), such as in the visible (i.e. about 380-780 nm, especially about 550-700 nm). In a specific embodiment, the optical sensor comprises the light source. Such embodiment provides an optical sensor that contains all relevant elements for sensing emission light upon excitation.

In a further specific embodiment, the light source is arranged to couple light source light into the waveguide, more especially, the light source and the waveguide are arranged to provide total internal reflection of the incoupled light source light. In an embodiment, the light source and the waveguide are arranged to provide incoupled light source light with an angle θ₁ relative to a normal to the sensor waveguide surface in a typical range of about 70-80°. Especially under such condition, excitation light, especially in the range of about 550-700 nm, may be coupled out relatively efficiently in first order, while at the same time having a relatively high transmission for emission light of the analyte, especially in the range of about 650-900 nm, especially about 650-750 nm.

In a specific embodiment, the diffraction grating is arranged to couple out excitation light with a predetermined wavelength in a first order diffraction substantially perpendicular to the sensor waveguide surface with a diffraction efficiency for the predetermined excitation wavelength, especially in the range of about 550-700 nm, in first order, and substantially perpendicular to the sensor waveguide surface, in the range of about 2-30%, especially in the range of about 2-20%, more especially in the range of about 2-15%, while being transparent under perpendicular illumination with emission light of a predetermined wavelength, especially in the range of about 650-900 nm, with a transmission efficiency of about 50-100%, especially in the range of about 80-100%. Further, in an embodiment, the light source, the waveguide, and the diffraction grating are arranged to provide polarized excitation light.

Thus, in a further aspect, the invention also provides a method for measuring emission light of an analyte with an optical sensor, such as for instance described above, comprising a, preferably substantially planar, waveguide and an optical detector, the method comprising:

a. coupling light from a light source into the waveguide;

b. illuminating the analyte with excitation light coupled out from the waveguide and allowing emission light, coupling into the waveguide as incoupled emission light;

c. coupling out at least part of the incoupled emission light in the direction of the optical detector as waveguide outcoupled emission light, and detecting at least part of the waveguide outcoupled emission light by the optical detector.

In a specific embodiment, the analyte is comprised in a liquid medium on a wire-grid substrate. The wire-grid substrate may comprise a transparent substrate and a wire-grid pattern attached to the transparent substrate. Hence, in an embodiment the wire-grid substrate comprises a transparent substrate having a surface comprising a grid pattern with a wire-grid pitch. The wire-grid substrate may especially have a wire-grid pattern with a wire-grid pitch, which is especially equal to or smaller than about λₑₓ/2n, wherein n is the refractive index of the liquid medium (which is in general in the range of about 1.3-1.6, such as water). Especially, the wire-grid pitch of the slits of the wire grid is smaller than the wavelength of the excitation light, and especially below the diffraction limit of the medium (that fills the slits of the wire grid). Therefore, in an embodiment, the pitch of the slits of the wire grid is smaller than about 50% of the wavelength of the excitation light (with the predetermined excitation wavelength), preferably smaller than about 40% of the wavelength of the excitation light. Polarized light with the predetermined polarization may be obtained by using polarized light and/or by using a polarization filter. In a further embodiment, the wire-grid pitch is selected from the range of about 30-350 nm, especially in the range of about 55-70 nm. Hence, such wire-grid substrates allow excitation from below and also detection of emission from below (the wire-grid substrate).

In an embodiment, the analyte may be contained in a biological sample, such as blood, salvia, tissue, etc. The analyte may optionally be labelled with a luminescent marker or label. Analytes may have luminescence properties from their own, but some analytes may only show, or only show a luminescence with a predetermined wavelength, after being labelled with luminescent markers or label. Such markers or labels are known in the art. Herein, the term luminescence and emission are equivalent.

Illuminating the analyte with excitation light may especially comprise illuminating the analyte with an evanescent optical field.

The term “evanescent optical field” is known in the art. In optics, evanescent waves are formed when light waves are (internally) reflected off an interface at an angle greater than the critical angle so that total internal reflection occurs. The physical explanation for their existence is that the electric and magnetic fields cannot be discontinuous at a boundary, as would be the case if there were no evanescent field.

Further, in the grid of the wire-grid substrate, an evanescent field may be created. In an embodiment, such evanescent field is created by illuminating with excitation light with a predetermined wavelength the wire-grid substrate from below, thereby exciting the analytes in the liquid medium on the wire-grid substrate. Especially such field can be used to probe or sense the analytes that may be bound to the surface of the substrate of the wire grid substrate.

Hence, the optical sensor of the invention is in an embodiment arranged to provide an evanescent optical field, with a predetermined excitation wavelength, in the wire grid (actually in the wells between the wires of the wire grid) of a predetermined wire-grid substrate, especially having a wire-grid pattern with a wire-grid pitch, which is especially equal to or smaller than about λₑₓ/2n. Especially, the excitation light has a polarization parallel to the wires of the wire grid. Hence, an embodiment of the method of the invention also comprises providing excitation light with a predetermined wavelength and polarization parallel to the wires of the wire grid.

Hence, the invention also provides a kit of parts comprising the optical sensor as described herein and one or more wire-grid substrates as defined herein, especially a plurality of such wire-grid substrates, and optionally one or more containers containing the medium liquid medium as defined herein, such as (demineralised) water or commercially available solutions comprising labels that can be used for labelling the analyte(s).

Further, in a specific embodiment the optical sensor further comprises the wire grid substrate, wherein the wire-grid substrate is arranged adjacent to the sensor waveguide surface (optionally comprising the diffraction grating), and wherein the wire-grid substrate is arranged substantially parallel to the sensor waveguide surface. Hence, in a specific embodiment, the optical sensor according to the invention is arranged to measure emission light from an analyte comprised by the wire-grid substrate, and the optical sensor is arranged to measure such emission light of the analyte comprises by the wire-grid substrate that is arranged adjacent to the sensor waveguide surface (optionally comprising the diffraction grating), and wherein the wire-grid substrate is arranged substantially parallel to the sensor waveguide surface. Especially, the wire-grid substrate and the optical sensor are arranged to have the sensor waveguide surface on top, and the wire-grid substrate adjacent, or more especially, on top of the sensor-waveguide surface (optionally comprising the diffraction grating).

In a further specific embodiment, the waveguide is a substantially planar structure, with the sensor waveguide surface and the detector directed waveguide surface being substantially parallel, wherein the light input waveguide surface is a surface of the waveguide that is substantially perpendicular to the sensor waveguide surface and the detector directed waveguide surface (or side surface), wherein the optical sensor comprises the light source, wherein the light source is arranged to provide light to the light input waveguide surface, wherein the optical sensor is arranged to measure emission light from the analyte comprised by the wire-grid substrate, and the optical sensor is arranged to measure such emission light of the analyte comprised by the wire-grid substrate that is arranged adjacent to the sensor waveguide surface (optionally comprising the diffraction grating), and wherein the wire-grid substrate is arranged substantially parallel to the sensor waveguide surface. Especially, the wire-grid substrate and the optical sensor are arranged to have the sensor waveguide surface on top, and the wire-grid substrate adjacent, or more especially, on top of the sensor-waveguide surface (optionally comprising the diffraction grating). The detector may be arranged below the waveguide, and may thus measure from below, i.e. the analyte in the wire-grid is excited from below and the luminescence is measured from below the wire-grid.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts an embodiment of the optical sensor according to the invention, and also schematically depicts how the sensor may operate; and

FIGS. 2a-c schematically depict an embodiment of the invention and also schematically depict how the sensor may operate, with FIG. 2b showing a detail of a part of the wire grid substrate.

### DESCRIPTION OF PREFERRED EMBODIMENTS

The Optical Sensor in General

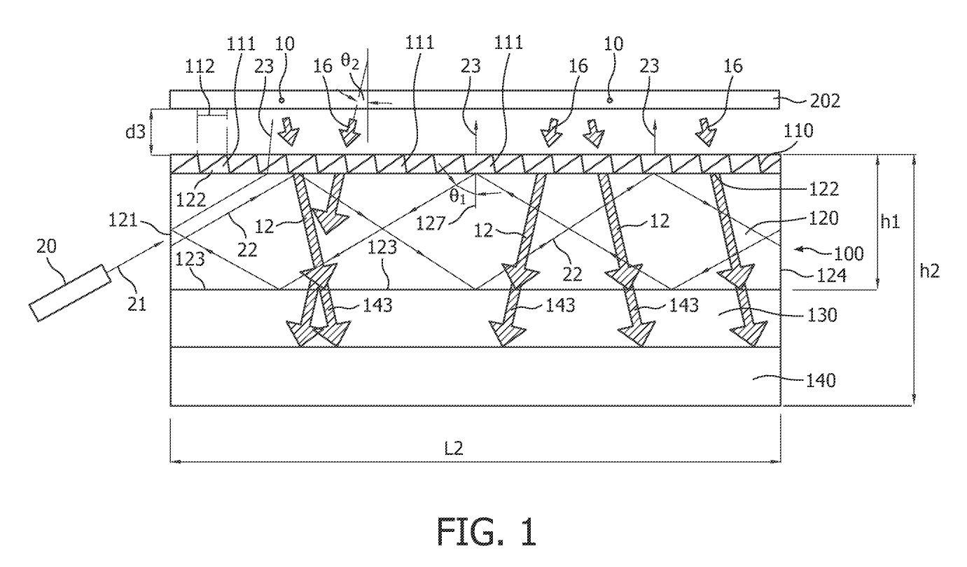

FIG. 1 schematically depicts an optical sensor 100 for measuring emission light 16 from an analyte 10. In this schematic embodiment, the light source, indicated with reference number 20, is not comprised in the optical sensor 100, although in other embodiments, this might be the case. The light source 20 is arranged to generate light 21 with a predetermined wavelength (including a predetermined wavelength range). The optical sensor 100 comprises in this embodiment a substantially planar waveguide 120 and an optical detector 140. The term “optical sensor” is herein substantially identical to the terms “emission sensor” or “luminescence sensor”

Light 21 from light source 20, that is coupled into the waveguide 120, is further indicated as light 22. The terms “couple in”, “incoupled”, “couple out”, “outcoupled” and similar terms, indicate that light enters at least partly from one medium, to another medium, for instance from ambient (in general air) into the waveguide 120, from the waveguide 120 into ambient (or directly into the analyte), from the waveguide 120 into an optical element (see below), etc. These terms are known in the art.

The dimensions of the optical sensor 100 may for instance be a length 12 in the range of about 5-50 mm, such as typically about 10 mm and a height h2 in the range of about 1-10 mm, such as typically about 2 mm. The width, not depicted, but perpendicular to the face of drawing, may be in the range of about 5-50 mm, such as typically about 10 mm. Typically, the dimensions of the optical sensor 100 may be about 10×10 mm.

Note that these dimensions relate to the waveguide 120, detector 140 and optional intermediate optics 130. Further means or parts such as a holder, a voltage source, a display, etc., known to the person skilled in the art, may not be included in these dimensions.

The Analyte

For the sake of understanding, an analyte 10 is depicted. As will be clear to the person skilled in the art, the analyte 10 is not part of the optical sensor 100.

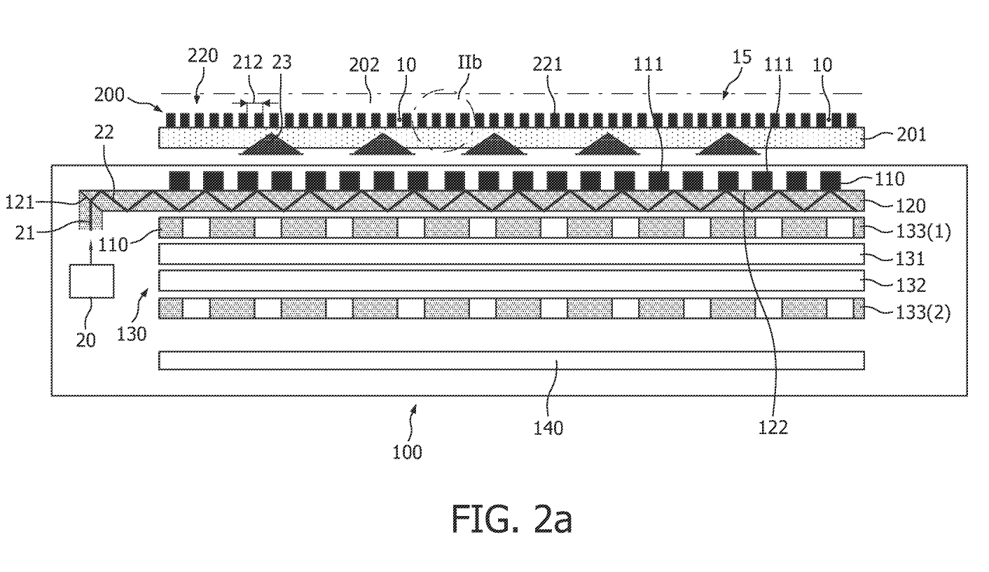

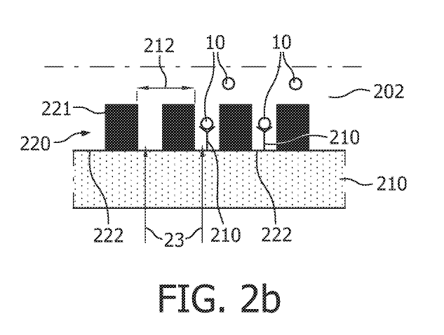

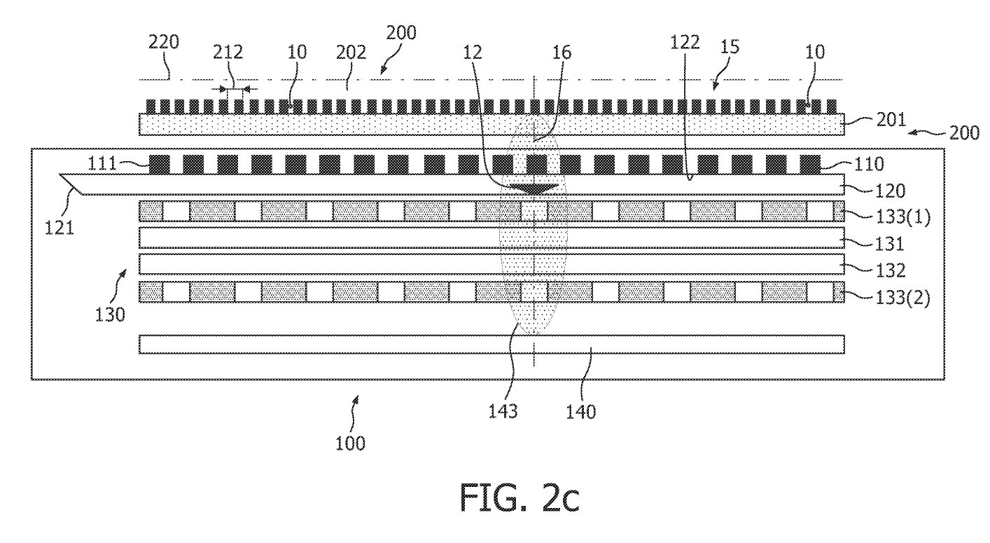

The analyte 10 can be any analyte, but in a specific embodiment the analyte 10 comprises a biological material. The term “analyte” relates to a material to be analyzed, especially a solid or liquid material. The analyte 10 may comprise molecules such as e.g., but not limited thereto, proteins, viruses, bacteria, cell components, cell membranes, spores, DNA, RNA, etc. in for instance a fluid, such as for example blood, serum, plasma, saliva, etc. The optical sensor 100 may especially be arranged to analyse, sense or detect emission of analytes 10 in fluids or fluid samples. These samples may be diluted in a liquid medium. In FIGS. 2a-2c, the liquid medium is indicated with reference 202. The liquid medium 202 in the schematically depicted embodiments comprises the analyte 10, and may thus in an embodiment comprise in a liquid medium mixed blood, serum, plasma or salvia sample, etc. Analytes 10, such as bio molecules, may be wished to be detected per se or the quantity of such analytes 10 may be wished to be investigated with the optical sensor 100 and method for measuring emission light 16 according to embodiments of the invention. The analyte 10 will in general be contained (in the liquid medium 202) on a substrate, see below.

Analytes 10 may luminescence from their own or may luminescence due to the presence of labels or markers. Note that the absence of luminescence of a specific analyte 10 does not limit the optical sensor 100 neither the method of the invention. The optical sensor 100 is arranged to detect or sense emission, but also the absence of emission may be an outcome of the method of the invention.

The Waveguide

Waveguides 120 are known in the art, and in general may comprise transparent materials, at least transparent for a predetermined (excitation and emission) wavelength, such as a wavelength selected from the range of about 250-1000 nm, or especially at least in the visible and infra-red, more especially in the range of about 550-900 nm. Suitable transparent materials may for instance be selected from the group consisting of PET (polyethylene terephthalate), PE (polyethylene), PP (polypropylene), PC (polycarbonate), P(M)MA (poly(methyl)metacrylate), PEN (polyethylene napthalate) and PDMS (polydimethylsiloxane), but also from the group selected from the group consisting of glasses, (fused) quartz, ceramics, and silicones.

The waveguide 120 comprises a light input waveguide surface 121 arranged to couple light 21 from the light source 20 into the waveguide 120. The waveguide 120 will in general have a front face, a back face and an edge (including edges). Part of the edge may be applied as light input waveguide surface 121. The part of the edge that is not applied to couple light into the waveguide 120, i.e. is not applied as light input waveguide surface 121, may comprise a reflective coating (not depicted), arranged to promote reflection of light with the predetermined wavelength back into the waveguide. The waveguide surface not being used as light input waveguide surface 121, and not being the front face or the back face, i.e. the part of the edge not being used to couple light 21 into the waveguide, is indicated with reference 124. The front face and back face are here, for the sake of understanding of the sensor 100, indicated as sensor waveguide surface 122 and detector directed waveguide surface 123, respectively.

The sensor waveguide surface 122 is arranged to couple out at least part of the incoupled light source light 22 as excitation light 23 to excite the analyte 10. In this way, the waveguide 120 is used as excitation source to excite the analyte 10 with at least part of the light source light 21 that has been coupled into the waveguide 120 as incoupled light source light 22. The waveguide 120 may further be arranged to allow total internal reflection of the incoupled excitation light.

Further, the waveguide 120 is also arranged to transmit at least part of the emission 16 of the analyte 10, especially emission light 16 perpendicular to the sensor waveguide surface 122. Hence, the sensor waveguide surface 122 is also arranged to couple into the waveguide 120 at least part of the emission light 16 from the analyte 10 as incoupled emission light 12.

The emission light 16 that is incoupled in the waveguide 120 as incoupled emission light 12 has to be detected or sensed by the detector 130. Hence, the waveguide 120 further comprises the detector directed waveguide surface 123, which is especially arranged substantially parallel with the sensor waveguide surface 122, and which is further arranged to couple out at least part of the incoupled emission light 12 in the direction of the optical detector 140 as waveguide outcoupled emission light 143. Then, this outcoupled emission light 143 may be detected by the detector 140. Hence, the optical detector 140 is arranged to detect at least part of the waveguide outcoupled emission light 143. The optical sensor 100 may be arranged to qualitatively and/or quantitatively analyse analytes 10.

The waveguide 120 may in an embodiment have a height h1 of about 0.1-1 mm and a length 12 of about 5-50 mm. The waveguide 120 may be square, rectangular or have other shapes. In general, the length 12 and the width (not drawn, but perpendicular to the face of the drawing) will both be in the order of about 5-50 mm. Especially, the waveguide 120 is square or rectangular. And, as mentioned above, preferably the waveguide 120 is planar, in order to be able to obtain a substantially planer optical sensor 100.

Waveguide Diffraction Grating

In a specific embodiment, the sensor waveguide surface 122 may comprise a diffraction grating 110, which may especially be arranged to couple out excitation light 23 with a predetermined wavelength in a first order diffraction substantially perpendicular to the sensor waveguide surface 122. Further, the diffraction grating 110 may especially be arranged to promote outcoupling of light in first order diffraction in a direction perpendicular to the sensor waveguide surface 122.

In the schematic FIG. 1, the excitation light 23 is schematically depicted as being substantially perpendicular to the sensor waveguide surface 122. Especially, the diffraction grating 110 is also substantially transmissive for emission light 16 with a predetermined wavelength (also indicated as λₑₘ), especially emission light 16 perpendicular to the sensor waveguide surface 122. Hence, excitation light 23 may especially be coupled out substantially perpendicular to the sensor waveguide surface 122 having a predetermined wavelength, and emission light 16 may substantially enter the waveguide 120 without substantially being diffracted into higher orders (order >0) by the diffraction grating 110. Hence, the diffraction grating 110 may also be indicated as dichroic grating or dichroic grating coupler. The pitch of the grating is indicated with reference 112. The grating structures, such as saw tooth or square wave structures, are here indicated with reference 111. Below, the dichroic grating coupler is elucidated in more detail.

For the grating coupler or diffraction grating 110 to work and to show dichroic behaviour, one can define a range of grating pitches 112 such that one wavelength λ (also indicated as λₑₓ) is being coupled out by the grating structure, whereas a red-shifted wavelength λ+Δλ (also indicated as λₑₘ) is transmitted by the grating structure. Here, n1 and n2 are refractive indices of the waveguide 120 (e.g. glass) and the medium surrounding the substrate (e.g. air); θ₁^{λ} is the angle of light rays with wavelength λ (i.e. λₑₓ) with respect to the surface normal, indicated with reference 127, inside the waveguide structure; θ₂ is the direction of the emission 16 light rays in air just above the grating structure; p is the grating pitch 112; ε denotes the divergence of the luminescent rays of light, to be collected by the optical sensor 100.

For the excitation wavelength λ one can write down the equation:

n₁ sin(θ₁^{λ})=n₂ sin(θ₂)±λ/p; n₂=1; θ₂=0

n₁ sin(θ₁^{λ})=±λ/p

For the emission wavelength λ+Δλ one can write down the equation:

n₁ sin(θ₁^{λ+Δλ})=n₂ sin(θ₂)±(λ+Δλ)/p

n₁ sin(θ₁^{λ+Δλ})=ε±(λ+Δλ)/p; ε=n₂ sin(θ₂)

where ε is a small number accounting for the divergence of the luminescent light (ε>0). For the excitation wavelength a first order exists (for incoupling of light). For the luminescent wavelength only the 0^{th} order exists: as a result all luminescent light is being transmitted by the waveguide.

Consequently:

λ/(p.n₁)<1

and

|ε/n₁±(λ+Δλ)/(p.n₁)|>1 [symbol] (λ+Δλ)/(p.n₁)−ε/n₁>1

Consequently: p>λ/n₁

and

p<(λ+Δλ)/(n₁+ε)

Consequently, the grating pitch must be in the range Δp:

Δp=(λ+Δλ)/(n₁+ε)−λ/n₁; Δp>0

for ε=0: Δp=Δλ/n₁

This imposes a maximum value for ε: ε<n₁·Δλ/λ

So there is a maximum acceptance angle θ₂ such that for angles below this maximum value no diffraction in higher orders occurs and all light in transmitted in the 0^{th} order diffraction order:

θ₂<θ_{2,max}=arc sin[(n₁n₂)·Δλ/λ]

To give an example, when λ=650 nm, Δλ=65 nm, n₁=1.5, n₂ =1, and ε=0, then θ_{2,max}=8.6°; for greater angles light is also coupled into higher diffraction orders. Δp=43.3 nm ; p may therefore be in the range of about 433-477 nm. For a grating pitch of p=450 nm, the entrance angle for excitation light (wavelength λ) is

ti n₁ sin(θ₁^{λ})=λ/p [symbol] θ₁^{λ}=arc sin(λ/p.n₁)=arc sin(650/450.1.5)=74°

The number of reflections off the top side of the waveguide (where the grating is), is N_{refl}

N_{refl}=2.w/(2h.tan(θ))=(w/h)/tan(74 )

For each reflection the grating transmits a fraction T of the incoming intensity.

The total amount of light coupled into the first order, is I^{1st}:

$$\begin{matrix}{I}^{1 st} = {I}_{0} T + {I}_{0} ( 1 - T ) T + {{I}_{0} ( 1 - T )}^{2} T + \\ {{I}_{0} ( 1 - T )}^{3} T + … + {{I}_{0} ( 1 - T )}^{Nrefl} T = \\ = {I}_{0} T \cdot [ 1 + ( 1 - T ) + {( 1 - T )}^{2} + … + {( 1 - T )}^{Nrefl} ] \\ = {I}_{0} T {\sum }_{n = 0}^{Nrefl} {( 1 - T )}^{n} \\ = {I}_{0} T \frac{1 - {( 1 - T )}^{Nrefl + 1}}{T} \\ = {I}_{0} [ 1 - {( 1 - T )}^{Nrefl + 1} ]\end{matrix}$$

w=20 mm, h=1 mm, θ=74°,T=10%: N_{refl}=5.7x; total outcoupling eff. I₁ₛₜ/I₀=50.6%.

w=20 mm, h=1 mm, θ=74°,T=5%: N_{refl}=5.7x; total outcoupling eff. I₁ₛₜ/I₀=29.9%.

Hence, in an embodiment, the grating 110 is especially designed such that the 1^{st} diffraction order is coupled out in a direction perpendicular to the sensor waveguide surface 122. The grating 110 can be further designed to transmit emission light 16 generated by excited analyte 10, so that this light 16 can be imaged using detector 140 at the detector directed waveguide surface 123 of the sensor 100.

In a specific embodiment, the predetermined wavelength of the excitation light 23 is selected from the range of about 550-700 nm. In a further specific embodiment, the diffraction grating 110 has a grating pitch 112 in the range of about 400-600, especially about 400-500 nm. Further, in a specific embodiment, the diffraction grating 110 may especially be designed such that theta θ_{2,max} is as large as possible, such as at least 5°, more especially in the range of 5-25°, especially in the range of 5-15°.

Detector and Further Optical Elements

The waveguide 120 is further arranged to couple out via the detector directed waveguide surface 123 (as outcoupled emission 143) at least part of the incoupled emission light 12 in the direction of the detector 140.

The detector 140 may for instance comprise a CCD or CDMOS detector or a photodiode. In a specific embodiment, the detector 140 is arranged to detect light with a wavelength selected from the range of about 650-900 nm.

The detection of the emission 16, more especially the outcoupled emission 143, may further be facilitated and or optimized by arranging one or more optical elements between the detector directed waveguide surface 123 and the detector 140, i.e. downstream from the detector directed waveguide surface 123 and upstream of the detector 140.

An optical element (which may include a plurality of optical elements) is indicated in FIG. 1 with reference 130. The one or more optical elements 130 may be selected from the group consisting of an optical filter 131, a polarizer 132 and a micro lens array 133.

Operation

The optical sensor 100 according to the invention can be used to detect analytes 10. Hence, according to a further aspect, the invention also provides a method for measuring emission light 16 of an analyte 10 with an embodiment of the optical sensor 100. The method comprises coupling light 21 from a light source 20 into the waveguide 120 and illuminating the analyte 10 with excitation light 23 coupled out from the waveguide 120. For the sake of understanding, this is further schematically indicated in FIG. 2a. Having measured emission or luminescence, further analysis of this emission or luminescence may be performed.

The method further comprises allowing emission light 16 (from the analyte 10), being coupled into the waveguide 120 as incoupled emission light 12 and further comprises allowing at least part of this incoupled emission light 12 being coupled out in the direction of the optical detector 140 as waveguide outcoupled emission light 143. The method further comprises then detecting at least part of the waveguide outcoupled emission light 143 by the optical detector 140. This method or process is for the sake of understanding further schematically indicated in FIG. 2c.

As known to the skilled person, excitation and emission may occur substantially simultaneously, depending upon the decay time(s) of the analyte luminescence(s). Note that in FIGS. 2a and 2c, the optical element 130 comprises a first micro lens array 133(1) downstream of the detector directed waveguide surface 122, downstream thereof an optical filter 131, downstream thereof a polarizer 132, and downstream thereof a second micro lens array 133(2), respectively. The micro lens arrays may be used to focus the outcoupled emission light 143 on the detector 140; the optical filter 131 may be used to filter undesired light, such as for instance part of the excitation light 21 that might reach the detector 140; and the polarizer may be used to filter out potential luminescent light generated in the bulk above the wire-grid substrate (see also below).

The aim of the optical filter 131 is especially to block unwanted excitation radiation. The wavelength filter or optical filter 131 should preferably show strong suppression, preferably better than two orders of magnitude, for the excitation light, but should preferably show substantially no suppression for the emission light. The transmission of luminescence light may preferably be better than 10% and more preferably may be better than 50%.

As mentioned above, the analyte 10 may be contained in a biological sample, optionally labelled with a luminescent marker or label. Such analyte 10 may be investigated on luminescence properties, i.e. analysed, by using the optical sensor 100 according to the invention and by illuminating the analyte 10 with an evanescent optical field.

Wire Grid Substrate and Kit

Especially advantageous is the use of a wire grid or wire-grid substrate in combination with the optical sensor 100 according to the invention. Such wire-grid substrate is schematically depicted in FIGS. 2a-2c and is indicated with reference 200. A detail of the wire grid 200 is schematically depicted in FIG. 2b. Herein, the wire grid 200 is also indicated as wire-grid substrate 200.

The wire grid substrate 200 may comprise a transparent substrate 201, which may comprise of one (or more) of the transparent materials indicate above (for the waveguide 120), such as glass or Perspex.

The wire-grid substrate 200 has surface 222, which surface 222 comprises a grating structure or wire grid 220. This wire grid 220, essentially consisting of parallel (metallic) wires or structures 221, has a pitch 212 between these parallel wires or structures 221. Typically the width or pitch 212 between the parallel wires or structures 221 (also indicated as slits) is less than about λₑₓ/(2n), where λₑₓ is the wavelength of the excitation light 23 and n is the refractive index of the medium in between the parallel wires or structures 221 of the wire grid substrate 200 (e.g. water). Hence, n is here especially in the range of about 1.3-1.6). In a further embodiment, the wire-grid pitch 212 is selected from the range of about 30-350 nm, especially in the range of about 55-70 nm. Between the wires 221, there are wells. The evanescent optical field may be generated between these wells. Wire grids are known in the art. The person skilled in the art may further derive information concerning wire-grid substrates from “Wire-grid diffraction gratings used as polarizing beam splitter for visible light and applied in liquid crystal on silicon”, M. Xu, H. Urbach, D. de Boer, and H. Cornelissen; Optics Express, Vol. 13, Issue 7, pp. 2303-2320 and WO 2006/136991.

Especially, the wire-grid substrate 200 is provided with capture probes 210 between the parallel structures or wires 221 of the grid pattern 220, i.e. arranged on and attached to the surface 222 of the transparent substrate 201. These capture probes 210 are arranged to capture predetermined analytes 10. In this way, the evanescent field created between the parallel wires 221 substantially only excites the analytes 10 attached to the surface 222 by capture probes 210.

Hence, in an embodiment, the wire-grid substrate 200 further comprises capture probes 210 attached to the surface 222 of the wire-grid substrate 200. The capture probes 210 are especially means to anchor analytes 10 to the surface 222 of the wire-grid substrate 200. Capture probes 210 are known in the art.

Undesired luminescent light not generated in the evanescent field in between the wires 221 of the wire grid 220, so being generated in the bulk (of liquid medium 202) above the wire grid 220, may have a polarization perpendicular to the emission light 16 generated by the excitation 23 due to the evanescent field. Hence, by using a polarizer 132 (see above), the undesired bulk emission can be filtered out. Further, the excitation light 23 is preferably polarized parallel to the wires 221 of the wire-grid 220. Such polarization may be obtained by using polarized excitation light and/or providing one or more polarizers, such as polarizing filters, upstream of the transparent substrate 201 of the wire-grid substrate 200. Polarizes are known in the art, and are not depicted in the schematic drawings.

In the schematic FIGS. 2a-2c, the liquid medium 202 containing the analyte 10 is over the wire grid substrate 200. For instance, this may be a film. In FIG. 2c, analytes 10 in the bulk are depicted, as well as analytes 10 captured by capture probes 210. The liquid medium surface is indicated with a dashed line.

Hence, in a specific embodiment, the optical sensor 100 is arranged to excite from below through a transparent substrate 201 of a wire-grid substrate 200 analytes 10, especially analytes 10 captured to the surface 222 of the transparent substrate 201 by capture probes 210, and is arranged to sense by sensor 140 the emission 16 of those analytes 10.

Therefore, the invention also provides in an embodiment the optical sensor 100 further comprising the wire grid substrate 200, wherein the analyte 10 is to be comprised in the liquid medium 202 on the wire-grid substrate 200, wherein the wire-grid substrate 200 has the grid pattern 220 with the wire-grid pitch 212 (see also above), wherein the wire-grid substrate 200 and the optical sensor 100 are further arranged to have the sensor waveguide surface 122 on top and the wire-grid substrate 200 adjacent to the sensor-waveguide surface 122, wherein the wire-grid substrate 200 is arranged adjacent to the sensor waveguide surface 122, and wherein the wire-grid substrate 200 is arranged substantially parallel to the sensor waveguide surface 122. The phrase “wherein the analyte 10 is to be comprised in the liquid medium 202 on the wire-grid substrate 200” indicates that during use of the optical sensor 100, the analyte 10 may be comprised in such liquid medium 202. However, the optical sensor 100, as well as the combination of the optical sensor 100 and the wire-grid substrate 200 and optionally also the light source 20, are not limited to configurations during use, where the analyte 10 may be present.

In further embodiment, the waveguide 120 is a substantially planar structure, with the sensor waveguide surface 122 and the detector directed waveguide surface 123 being substantially parallel, wherein the light input waveguide surface 121 is a surface of the waveguide that is substantially perpendicular to the sensor waveguide surface 122 and the detector directed waveguide surface 123, wherein the optical sensor 100 comprises the light source 20, wherein the light source 20 is arranged to provide light 21 to the light input waveguide surface 121, wherein the optical sensor 100 is arranged to measure emission light 16 from the analyte 10, and wherein excitation light 23 is provided to the wire-grid substrate 200 from below. The detector 140 may also be arranged below the waveguide 120, and may thus measure from below. As will be clear to the person skilled in the art, the wire-grid substrate 200 and analyte 10 will especially be arranged in the above described and herein depicted way during operation of the device 100.

Thus, in an embodiment, a planar waveguide 120 is provided capable of emitting radiation 22 in a direction perpendicular to the sensor waveguide surface 122 and capable of accepting and transmitting radiation 16 to detector 140, preferably a planar detector 140, with optionally one or more lenses 133, one or more spectral filters 131 and one or more polarisation filters 132 arranged between the waveguide 120 and the detector 140. Such detector 140 is especially arranged opposite of the sensor waveguide surface 122 (i.e. the planar detector is substantially parallel with the sensor waveguide surface 122), and especially such that the waveguide 120 is arranged between an analyte 10 and the detector 140.

The optical sensor 100 is especially arranged to read out a wire-grid substrate 200 with analytes 10.

Hence, in a specific embodiment, the waveguide 120 with sensor waveguide surface 122 comprising the diffraction grating 110, is arranged to allow total internal reflection of incoupled light 22 and is further arranged to allow outcoupling (especially in first order) of part of the light 22 via sensor waveguide surface 122, substantially perpendicular to this sensor waveguide surface 122, as excitation light 23 with a predetermined excitation wavelength, and is further arranged to allow emission light 16, with a predetermined emission wavelength, couple into the waveguide 120 via sensor waveguide surface 122 as incoupled emission light 12.

More especially, the light source 20 and the waveguide 120 with sensor waveguide surface 122 comprising the diffraction grating 110, are arranged to allow total internal reflection of incoupled light 22 from light source 20, and are further arranged to allow outcoupling (especially in first order) of part of the light 22 via sensor waveguide surface 122, substantially perpendicular to this sensor waveguide surface 122, as excitation light 23 with a predetermined excitation wavelength, and are further arranged to allow emission light 16, with a predetermined emission wavelength, couple into the waveguide 120 via sensor waveguide surface 122 as incoupled emission light 16.

Even more especially, the light source 20 and the waveguide 120 with sensor waveguide surface 122 comprising the diffraction grating 110, are arranged to allow total internal reflection of incoupled light 22 from light source 20, and are further arranged to allow outcoupling (especially in first order) of part of the light 22 via sensor waveguide surface 122, substantially perpendicular to this sensor waveguide surface 122, as excitation light 23 with a predetermined excitation wavelength, wherein the excitation light 23 is linearly polarized, and are further arranged to allow emission light 16, with a predetermined emission wavelength, couple into the waveguide 120 via sensor waveguide surface 122 as incoupled emission light 16.

Hence, the optical sensor 100 may especially be arranged to measure emission of the analyte 10, and may even be more arranged to measure such analyte 10 arranged on a dedicated wire grid 200. Hence, the combination of wire grid 10 and optical sensor 100 is also part of the present invention.

Hence, in this invention, the excitation source, here the waveguide 120 in combination with the light source 20 and the detector 140 are located at same side of analyte 10 to be detected or sensed, especially at the same side of the wire-grid substrate 200.

Therefore, the invention also provides a kit of parts comprising the optical sensor 100, as described herein, and one or more wire-grid substrates 200, as defined herein, especially a plurality of such wire-grid substrates 200 (such as 10-1000), and optionally one or more containers containing the medium liquid medium 202 as defined herein, such as (demineralised) water or commercially available solutions comprising labels that can be used for labelling the analyte(s) 10.

The optical sensor 100 according to embodiments of the invention may especially be used to measure luminescence of bio analytes. Hence, the optical sensor 100 may also be indicated as optical bio sensor 100.

### EXAMPLE

For a number of configurations, the optical properties of the specific optical sensor 100 were determined. For the sake of understanding, an example is given.

Using rigorous coupled wave calculations, a grating has been designed coupling out light at an excitation wavelength of 650 nm and transmitting light at an emission wavelength of 715 nm (10% red shift). A grating pitch of 450 nm has been used, the periodic structures having a saw-tooth (blazed) shape with a total height of 420 nm. It appears that for the indicated excitation wavelength around 9% of the light is coupled out in first order, whereas for the emission wavelength a transmission of 100% can be obtained for most entrance angles. For large entrance angles (larger than e.g. 10 degrees) the 0-order diffraction efficiency starts to decrease due to the appearance of higher order diffraction orders.

The term “substantially” herein, such as in “substantially all emission” or in “substantially consists”, will be understood by the person skilled in the art. The term “substantially” may also include embodiments with “entirely”, “completely”, “all”, etc.

Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation, for instance during excitation of the analyte. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims.

In particular, even though the invention described above refers to a measurement of an emission light irradiated from the analyte (e.g fluorescence, chemiluminescence light, etc.), it also applies to other kinds of light known in the art, like scattered or reflected light from the analyte.

By way of example, the device of the invention can advantageously be used in a biosensor based on FTIR (Frustrated Total Internal Reflection), in which the detection is notably based on measuring the light reflected from the surface of the biosensor, i.e. where the analyte takes place.

In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An optical sensor (100) for measuring light (16) irradiated from an analyte (10) upon light excitation, the optical sensor (100) comprising a planar waveguide (120) and an optical detector (140), the waveguide (120) comprising:
a. a light input waveguide surface (121) arranged to couple light (21) from a light source (20) into the waveguide (120);
b. a sensor waveguide surface (122) arranged to couple out at least part of the incoupled light source light (22) as excitation light (23) to excite the analyte (10) and arranged to couple into the waveguide (120) at least part of the light (16) irradiated from the analyte (10) as incoupled emission light (12);
c. a detector directed waveguide surface (123) arranged substantially parallel with the sensor waveguide surface (122), and arranged to couple out at least part of the incoupled emission light (12) in the direction of the optical detector (140) as waveguide outcoupled emission light (143);
wherein the optical detector (140) is arranged to detect at least part of the waveguide outcoupled emission light (143).

2. The optical sensor (100) according to claim 1, wherein the sensor waveguide surface (122) comprises a diffraction grating (110), wherein the diffraction grating (110) is arranged to couple out excitation light (23) with a predetermined wavelength in a first order diffraction substantially perpendicular to the sensor waveguide surface (122).

3. The optical sensor (100) according to claim 2, wherein the predetermined wavelength of the excitation light (23) is selected from the range of 550-700 nm.

4. The optical sensor (100) according to claim 2, wherein the diffraction grating (110) has a grating pitch (112) in the range of 400-500 nm.

5. The optical sensor (100) according to claim 1, wherein downstream of the detector directed waveguide surface (123) and upstream of the detector (140) one or more optical elements (130) selected from the group consisting of an optical filter (131), a polarizer (132) and a micro lens array (133) are arranged.

6. The optical sensor (100) according to claim 1, wherein the optical sensor (100) is a substantially planar device.

7. The optical sensor (100) according to claim 1, further comprising a wire grid substrate (200) extending substantially parallel to, and adjacent of the sensor waveguide surface (122), such that the light coupled out from the sensor waveguide surface (122) can excite the analyte (10) via the wire grid substrate.

8. The optical sensor (100) according to claim 7, wherein the light input waveguide surface (121) is substantially perpendicular to the sensor waveguide surface (122) and to the detector directed waveguide surface (123).

9. The optical sensor (100) according to claim 8, further comprising the light source (20), wherein the light source (20) is positioned on a side of the light input waveguide surface (121).

10. A method for measuring light (16) irradiated of an analyte (10) upon light excitation with an optical sensor (100) comprising a planar waveguide (120) and an optical detector (140), the method comprising:
a. coupling light (21) from a light source (20) into the waveguide (120);
b. illuminating the analyte (10) with excitation light (23) coupled out from the waveguide (120) and allowing light (16) irradiated from the analyte to couple into the waveguide (120) as incoupled light (12);
c. coupling out at least part of the incoupled light (12) in the direction of the optical detector (140) as waveguide outcoupled light (143), and detecting at least part of the waveguide outcoupled light (143) by the optical detector (140).

11. The method according to claim 10, wherein the optical sensor (100) comprises a sensor waveguide surface (122) arranged to couple out at least part of the incoupled light source light (22) as excitation light (23) to excite the analyte (10) and arranged to couple into the waveguide (120) at least part of the light (16) irradiated from the analyte (10) as incoupled light (12), and wherein the sensor waveguide surface (122) comprises a diffraction grating (110), wherein the diffraction grating (110) is arranged to couple out the excitation light (23) with a predetermined wavelength in a first order diffraction substantially perpendicular to the sensor waveguide surface (122).

12. The method according to claim 10, wherein the analyte (10) is a biological sample and wherein the biological sample is optionally labelled with a luminescent marker or label.

13. The method according to claim 10, wherein illuminating the analyte (10) with excitation light comprises illuminating the analyte (10) with an evanescent optical field.

14. The method according to claim 10, wherein the analyte (10) is comprised in a liquid medium (202) on a wire-grid substrate (200), the wire-grid substrate (200) comprising a transparent substrate (201) having a surface (222) comprising a grid pattern (220) with a wire-grid pitch (212), wherein the excitation light (23) has a predetermined wavelength (λₑₓ), and wherein the wire-grid pitch (212) of the grid pattern (210) is equal to or smaller than λₑₓ/2n, wherein n is the refractive index of the medium (202).

15. A kit of parts comprising the optical sensor (100) for measuring light (16) irradiated from an analyte (10) upon light excitation, the optical sensor (100) comprising a planar waveguide (120) and an optical detector (140), the waveguide (120) comprising:
a. a light input waveguide surface (121) arranged to couple light (21) from a light source (20) into the waveguide (120);
b. a sensor waveguide surface (122) arranged to couple out at least part of the incoupled light source light (22) as excitation light (23) to excite the analyte (10) and arranged to couple into the waveguide (120) at least part of the light (16) irradiated from the analyte (10) as incoupled emission light (12);
c. a detector directed waveguide surface (123) arranged substantially parallel with the sensor waveguide surface (122), and arranged to couple out at least part of the incoupled emission light (12) in the direction of the optical detector (140) as waveguide outcoupled emission light (143);
wherein the optical detector (140) is arranged to detect at least part of the waveguide outcoupled emission light (143) and one or more wire grid substrates (200) as defined in claim 15, and optionally one or more containers containing the liquid medium (202) as defined in claim 15.
